(19) United States
(12) Patent Application Publication
(10) Pub. No.: US 2019/0220677 A1
(43) Pub. Date: Jul. 18, 2019

(54) STRUCTURED LIGHT ILLUMINATION SYSTEM FOR OBJECT DETECTION

(71) Applicant: GM Global Technology Operations LLC, Detroit, MI (US)

(72) Inventors: Ariel Lipson, Tel Aviv (IL); Dan Levi, Kyriat Ono (IL); Ran Y. Gazit, Ra'Anana (IL)

(21) Appl. No.: 15/873,319

(22) Filed: Jan. 17, 2018

(51) Int. Cl. G06K 9/00; G01S 17/93; G05D 1/02

(52) U.S. Cl. CPC G06K 9/00798; G06K 9/00805; G05D 1/0238; G01S 17/93

(57) ABSTRACT

A vehicle, detection system and method for detecting a location of an object with respect to a vehicle is disclosed. The method includes transmitting, at the vehicle, a structured light pattern at a selected frequency into a volume that includes the object and receiving, at a detector of the vehicle, a reflection of the light pattern from the volume. A processor determines a deviation in the reflection of the structured light pattern due to the object in the volume and determines a location of the object in the volume from the deviation.

### INTRODUCTION

The subject invention relates to vehicle navigation and object detection and in particular to systems and methods for determining an object's location from a reflection of a structured light pattern from the object.

Driver-assisted vehicles can include a digital camera that takes a view of an area surrounding the vehicle in order to provide a view of blind spots and other hard-to-see areas. Such cameras work well in the daylight but can be impaired at night. Accordingly, it is desirable to provide a system and method for augmenting the ability of the digital camera at night or during other difficult viewing conditions.

### SUMMARY

In one exemplary embodiment, a method for detecting a location of an object with respect to a vehicle is disclosed. The method includes transmitting, at the vehicle, a structured light pattern at a selected frequency into a volume that includes the object and receiving, at a detector of the vehicle, a reflection of the light pattern from the volume. A processor determines a deviation in the reflection of the structured light pattern from the object in the volume, and determines the location of the object in the volume from the deviation.

The structured light pattern can be a pattern of vertical stripes. The deviation can be determined by comparing reflection intensities at a location with an expected intensity at the location from a line model indicative of reflection of the structure light pattern from a planar horizontal surface. In various embodiments, the vehicle can be navigated based on the location of the object.

An image of the object can be captured and compared to the deviation in the reflection of the light pattern in order to train a neural network to associate the deviation in the reflection of the structured light pattern with the object. The location of an object can then be determined from a location of a deviation in a reflection of the light pattern and the association of the trained neural network. The structured light pattern can be produced, for example, by one of a diffractive lens combined with a one-dimensional microelectromechanical system (MEMS) scanner, refractive optics with a two-dimensional MEMS scanner, an array of light sources, a polygon scanner, and an optical phase array.

In another exemplary embodiment, a system for detecting a location of an object with respect to a vehicle is disclosed. The system includes an illuminator configured to produce a structured light pattern into a volume at a selected frequency, a detector configured to detect a reflection of the light pattern from an object in the volume, and a processor. The processor is configured to: determine a deviation in the reflection of the light pattern due to the object; and determine the location of the object from the determined deviation.

The illuminator produces a pattern of vertical stripes at the selected frequency. The processor determines the deviation by comparing reflection intensities at a selected location with an expected intensity at the selected location from a line model indicative of reflection of the structure light pattern from a planar horizontal surface. The processor can then navigate the vehicle based on the detected location of the object.

In an embodiment, the processor illuminates the object with the pattern and compares the deviation in the reflection of the light pattern to an image of the object that causes the deviation in order to train a neural network to associate the deviation of the light pattern with the selected object. The processor can then determine a location of an object from the location of a deviation in the reflection of the light pattern and the association of the trained neural network.

The illuminator includes can be one of a diffractive lens combined with a one-dimensional microelectromechanical system (MEMS) scanner, refractive optic with a two-dimensional MEMS scanner, an array of light sources, a polygon scanner, and an optical phase array, in various embodiments. The detector can include a filter that passes light within the visible range and with a selected range about 850 nanometers.

In yet another exemplary embodiment, a vehicle is disclosed. The vehicle includes an illuminator configured to produce a structured light pattern in a volume at a selected frequency, a detector configured to detect a reflection of the light pattern from the volume, and a processor. The processor determines a deviation in the reflection of the light pattern due to the object, and determine a location of the object from the determined deviation.

The illuminator produces a pattern of vertical stripes at the selected frequency. The processor determines the deviation by comparing reflection intensities at a selected location with an expected intensity at the selected location from a line model indicative of reflection of the structure light pattern from a planar horizontal surface.

The processor illuminates the object with the pattern and compares the deviation in the reflection of the light pattern to an image of the object that causes the deviation in order to train a neural network to associate the deviation of the light pattern with the selected object. The processor can then determine a location of an object from a location of a deviation in a reflection of the light pattern and the association of the trained neural network.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 shows a trajectory planning system generally associated with a vehicle in accordance with various embodiments;

FIG. 2 shows an object detection system usable with the vehicle of FIG. 1;

FIG. 3 shows a response spectrum of an illustrative detector;

FIG. 4 shows a passband spectrum of an illustrative filter that can be used with the illustrative detector;

FIG. 5 shows an image illustrating a projection of the vertical striped pattern onto a flat horizontal plane, such as pavement;

FIG. 6 shows an image illustrating the effects of the presence of an object on a reflection of the vertical stripes of FIG. 5;

FIG. 7 shows a recording or image of the reflection of the vertical stripes from the object;

FIG. 8 illustrates a scene having a plurality of objects therein;

FIG. 9 shows a flowchart illustrating a method in which the reflection of infrared light and the visual images can be used to train a neural network or model to recognize objects; and

FIG. 10 shows a flowchart illustrating a method of navigating a vehicle using the methods disclosed herein.

### DETAILED DESCRIPTION

The following description is merely exemplary in nature and is not intended to limit the present disclosure, its application or uses. It should be understood that throughout the drawings, corresponding reference numerals indicate like or corresponding parts and features.

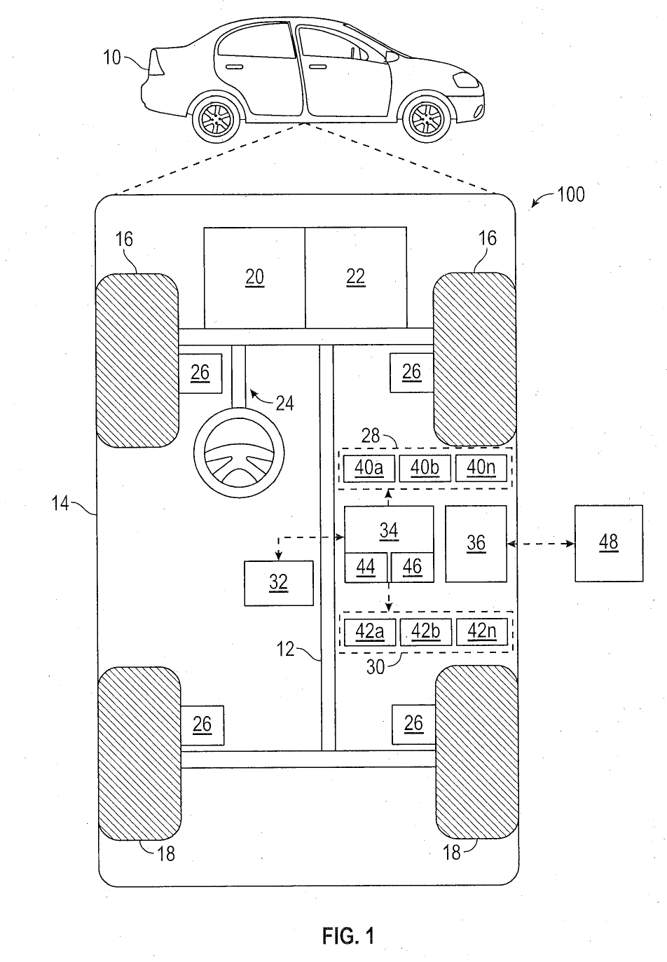

In accordance with an exemplary embodiment of the invention, FIG. 1 shows a trajectory planning system generally at 100 associated with a vehicle 10 in accordance with various embodiments. In general, system 100 determines a trajectory plan for automated driving. As depicted in FIG. 1, the vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16-18 are each rotationally coupled to the chassis 12 near a respective corner of the body 14.

In various embodiments, the vehicle 10 is an autonomous vehicle and the trajectory planning system 100 is incorporated into the autonomous vehicle 10 (hereinafter referred to as the autonomous vehicle 10). The autonomous vehicle 10 is, for example, a vehicle that is automatically controlled to carry passengers from one location to another. The autonomous vehicle 10 is depicted in the illustrated embodiment as a passenger car, but it should be appreciated that any other vehicle including motorcycles, trucks, sport utility vehicles (SUVs), recreational vehicles (RVs), marine vessels, aircraft, etc., can also be used. In an exemplary embodiment, the autonomous vehicle 10 is a so-called Level Four or Level Five automation system. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver.

As shown, the autonomous vehicle 10 generally includes a propulsion system 20, a transmission system 22, a steering system 24, a brake system 26, a sensor system 28, an actuator system 30, at least one data storage device 32, at least one controller 34, and a communication system 36. The propulsion system 20 may, in various embodiments, include an internal combustion engine, an electric machine such as a traction motor, and/or a fuel cell propulsion system. The transmission system 22 is configured to transmit power from the propulsion system 20 to the vehicle wheels 16-18 according to selectable speed ratios. According to various embodiments, the transmission system 22 may include a step-ratio automatic transmission, a continuously-variable transmission, or other appropriate transmission. The brake system 26 is configured to provide braking torque to the vehicle wheels 16-18. The brake system 26 may, in various embodiments, include friction brakes, brake by wire, a regenerative braking system such as an electric machine, and/or other appropriate braking systems. The steering system 24 influences a position of the of the vehicle wheels 16-18. While depicted as including a steering wheel for illustrative purposes, in some embodiments contemplated within the scope of the present disclosure, the steering system 24 may not include a steering wheel.

The sensor system 28 includes one or more sensing devices 40a-40n that sense observable conditions of the exterior environment and/or the interior environment of the autonomous vehicle 10. The sensing devices 40a-40n can include, but are not limited to, radars, LIDARs, global positioning systems, optical cameras, digital cameras, thermal cameras, ultrasonic sensors, and/or other sensors. The actuator system 30 includes one or more actuator devices 42a-42n that control one or more vehicle features such as, but not limited to, the propulsion system 20, the transmission system 22, the steering system 24, and the brake system 26. In various embodiments, the vehicle features can further include interior and/or exterior vehicle features such as, but are not limited to, doors, a trunk, and cabin features such as air, music, lighting, etc. (not numbered).

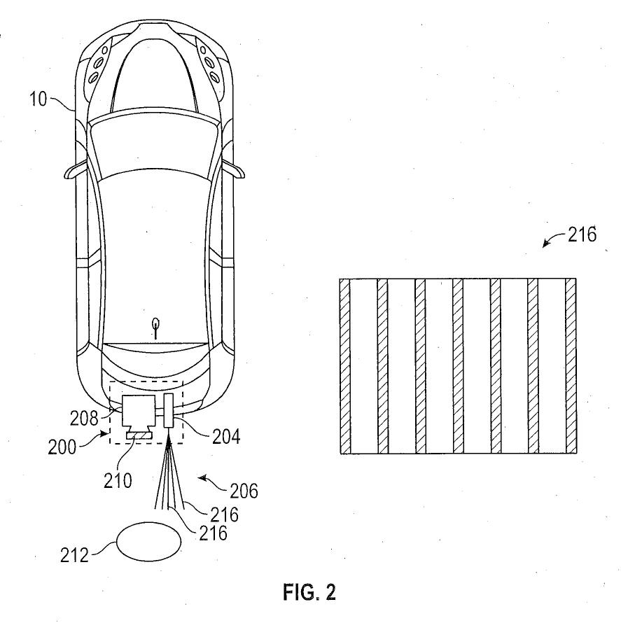

The data storage device 32 stores data for use in automatically controlling the autonomous vehicle 10. In various embodiments, the data storage device 32 stores defined maps of the navigable environment. In various embodiments, the defined maps may be predefined by, and obtained from, a remote system (described in further detail with regard to FIG. 2). For example, the defined maps may be assembled by the remote system and communicated to the autonomous vehicle 10 (wirelessly and/or in a wired manner) and stored in the data storage device 32. As can be appreciated, the data storage device 32 may be part of the controller 34, separate from the controller 34, or part of the controller 34 and part of a separate system.

The controller 34 includes at least one processor 44 and a computer readable storage device or media 46. The processor 44 can be any custom made or commercially available processor, a central processing unit (CPU), a graphics processing unit (GPU), an auxiliary processor among several processors associated with the controller 34, a semiconductor based microprocessor (in the form of a microchip or chip set), a macroprocessor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the autonomous vehicle 10.

The instructions may include one or more separate programs, each of which comprises an ordered listing of executable instructions for implementing logical functions. The instructions, when executed by the processor 44, receive and process signals from the sensor system 28, perform logic, calculations, methods and/or algorithms for automatically controlling the components of the autonomous vehicle 10, and generate control signals to the actuator system 30 to automatically control the components of the autonomous vehicle 10 based on the logic, calculations, methods, and/or algorithms. Although only one controller 34 is shown in FIG. 1, embodiments of the autonomous vehicle 10 can include any number of controllers 34 that communicate over any suitable communication medium or a combination of communication mediums and that cooperate to process the sensor signals, perform logic, calculations, methods, and/or algorithms, and generate control signals to automatically control features of the autonomous vehicle 10.

In various embodiments, one or more instructions of the controller 34 are embodied in the trajectory planning system 100 and, when executed by the processor 44, projects a structured light pattern into a volume proximate the vehicle 10 and records a reflection of the structured light pattern from one or more objects in the volume in order to determine the presence and/or location of the object within the volume.

The communication system 36 is configured to wirelessly communicate information to and from other entities 48, such as but not limited to, other vehicles (“V2V” communication), infrastructure (“V2I” communication), remote systems, and/or personal devices (described in more detail with regard to FIG. 2). In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

In other embodiments, the vehicle 10 can be a non-autonomous vehicle or a driver-assisted vehicle. The vehicle may provide audio or visual signals to warn the driver of a presence of an object, allowing the driver to take a selected action. In various embodiments, the vehicle provides a visual signal to the driver that allows the driver to view an area surrounding the vehicle, in particular, an area behind the vehicle.

FIG. 2 shows an object detection system 200 usable with the vehicle 10 of FIG. 1. The object detection system 200 includes an illuminator 204, also referred to herein as a “structured illuminator,” that projects a structured pattern of light 206 into a volume. In various embodiments, the structured pattern of light 206 is a pattern of vertical stripes 216 that are equally spaced and several degrees apart. In alternate embodiments, the structured pattern can be a stack of horizontal stripes, a dot matrix, a cross-hair pattern, concentric circles, etc. In various embodiments, the structured illuminator 204 generates light at a frequency in the infrared region of the electromagnetic spectrum, such as at about 850 nanometers (nm).

In various embodiments, the structured illuminator 204 employs a diffractive lens to form the vertical stripes 216. The diffractive lens can include a refractive element combined with a one-dimensional microelectromechanical system (MEMS) scanner, in an embodiment of the present invention. Alternatively, the diffractive lens may combine refractive optics with a two-dimensional MEMS scanner. In further alternative embodiments, the illuminator 204 can include an optical phase array, a vertical-cavity surface-emitting laser (VCSEL) imaged via refractive optics, a polygon scanner, etc.

The light 206 projected into the volume is reflected by an object 212 and is then received at detector 208. In one embodiment, the detector 208 is a complementary metal-oxide semiconductor (CMOS) pixel array that is sensitive to light in the visible light spectrum (e.g., from about 400 nm to about 700 nm) as well as light in the infrared spectrum, e.g., at about 850 nm. A filter 210 is disposed over the detector 208. The filter 210 passes light within the visible spectrum as well as in the infrared region of electromagnetic radiation. In various embodiments, the filter 210 allows light at a frequency within a range of about 850 nm. In one mode, the detector 208 can be used as a visible light imaging device when the structured illuminator 204 is not is use. For example, the detector 208 can capture an image from behind the vehicle 10 in order to provide the image to a driver of the vehicle 10 or to a processor that detects the object and/or navigates the vehicle 10. In another mode, the structured illuminator 204 can be activated to produce the structured pattern of light 206 in the infrared region (e.g., at about 850 nm) and the detector 208 can capture both the visual image and the reflection of the structured pattern of infrared light. The visual image captured by the detector 208 can be used with the reflection of the structured pattern of light to determine a location of the objects. In alternative embodiments, only the light at 850 nm is used to detect and locate objects.

While the detector 208 and structured illuminator 204 are shown at a rear location of the vehicle 10 in order to assist the driver as the vehicle is backing up, the detector 208 and illuminator 204 can be placed anywhere on the vehicle for any suitable purposes.

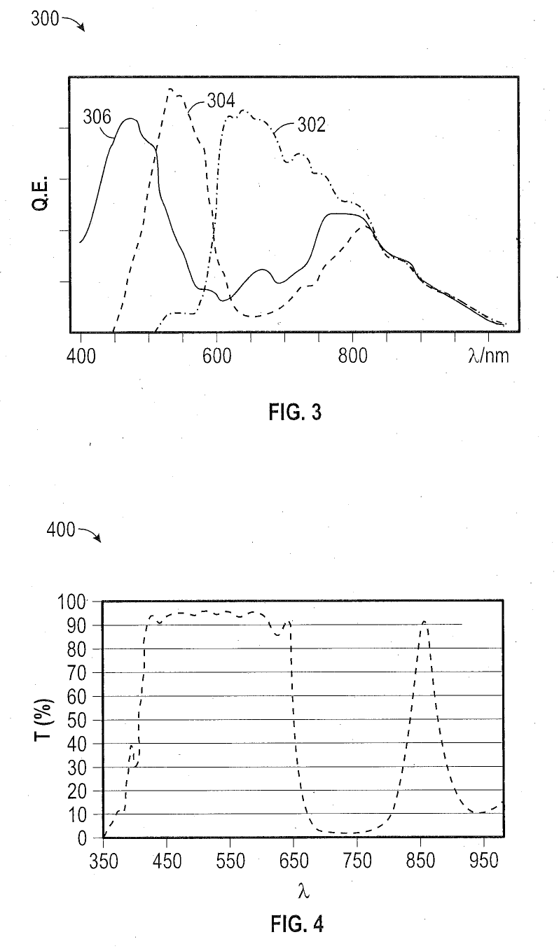

FIG. 3 shows a response spectrum of an illustrative detector 208, FIG. 2, showing a quantum efficiency (QE) of pixels at various wavelengths (λ). In various embodiments, the detector 208 includes a plurality of pixels, with each pixel designed to be sensitive to, or responsive to, a particular wavelength of light. By employing a plurality of these pixels, the detector is responsive to a plurality of wavelengths, such as red (302), green (304) and blue light (306), for example. While the sensitivity of the pixels peaks at their respective wavelengths, the pixels are also sensitive to radiation in the infrared region, i.e. between about 700 nm to about 1000 nm.

FIG. 4 shows a passband spectrum 400 of an illustrative filter 210, FIG. 2, that can be used with the detector 208 of the present invention. The passband spectrum 400 shows a transmission (T) of light at various wavelengths (λ). The filter 210 allows visible light to reach the detector 208 as well as infrared light in a region of about 850 nm.

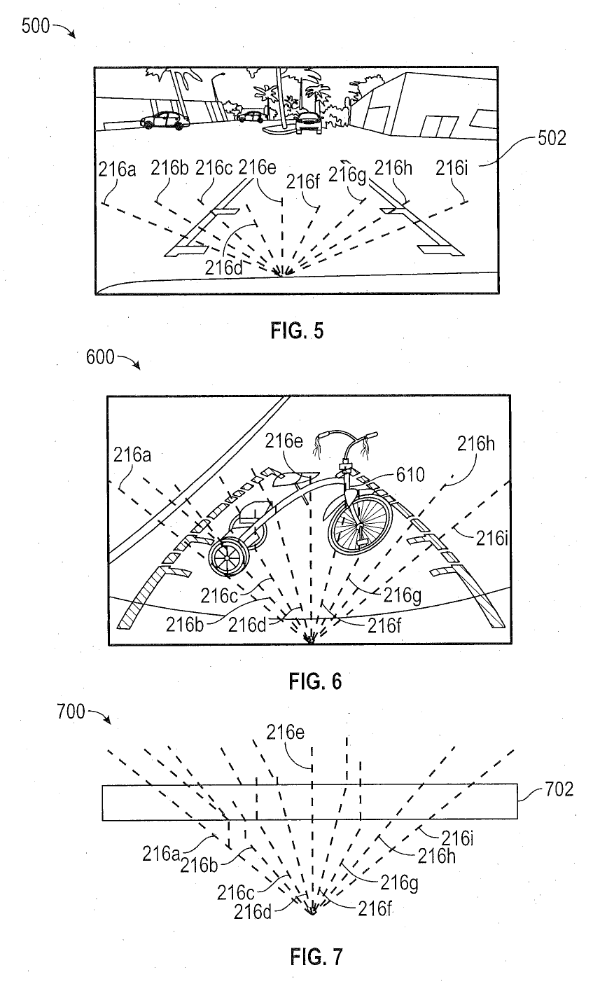

FIG. 5 shows an image 500 illustrating a projection of the vertical striped pattern 216 onto a flat horizontal plane, such as pavement 502. When illuminating the pavement 502, the vertical stripes 216a-216i transmitted by the structured illuminator (204, FIG. 2) forms a set of lines that diverge or fan out as they extend away from the illuminator 204 or vehicle 10. Since the vertical stripes 216a-216i have a finite height, the projection of the vertical stripes 216a-216i extends a selected distance from the vehicle 100, providing a detection range for the object detection system 200. In various embodiments, the vertical stripes 216a-216i define a detection region that extends up to about 5 meters from the vehicle.

FIG. 6 shows an image 600 illustrating the effects of the presence of an object 610 on a reflection of the vertical stripes 216a-216i of FIG. 5. For illustrative purposes, the object 610 is a tricycle. Stripes that do not intersect the tricycle, such as stripes 216a, 216h and 216i, remain as divergent straight lines along the pavement. However, stripes that do intersect the tricycle, such as stripes 216c, 216d, 261e, 216f and 216g, are bent by the tricycle.

FIG. 7 shows a recording or image 700 of the reflection of the vertical stripes 216a-216i from the object 610. In order to detect the object 610, a sliding scanning window 720 can be moved through the detected image 700 in order to detect the deviation in the recorded reflection. In an embodiment, the processor accesses a stored line model that indicates the location of a reflection of the vertical stripes from a smooth horizontal surface, such as the pavement 502. As the sliding window 702 moves through the image 700, the processor measures reflective energy at locations indicated by the stored line model. The reflective energy at these locations are compared to an energy threshold in order to detect the deviations of the reflected lines from the line model. The locations and or shapes of the deviations determine the general shape and location of the object 610, which can be used to warn the driver of the vehicle 10.

In one embodiment, the processor determines the location of the deviations in the vertical strips 216a-216i and tracks the changed direction of the reflected lines due to the presence of the object 610, FIG. 6. The locations of the deviations can be used to allow the processor to determine a location of the object.

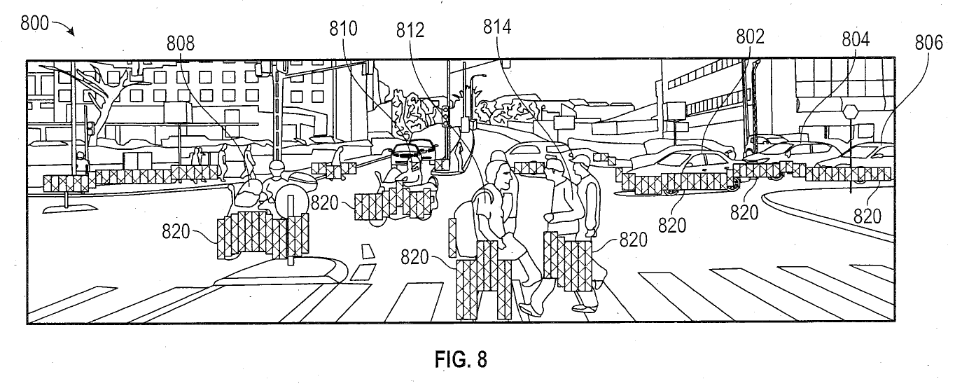

FIG. 8 illustrates a scene 800 having a plurality of objects 802, 804, 806, 808, 810, 812 and 814 therein. Boundary boxes 820 determined using the methods discloses herein are shown superimposed on the objects 802, 804, 806, 808, 810, 812 and 814. While, the boundary boxes 820 can be determined using the projection of the structured light pattern alone, in some embodiments, the information obtained from the structure light pattern is combined with methods for object detection from visual images.

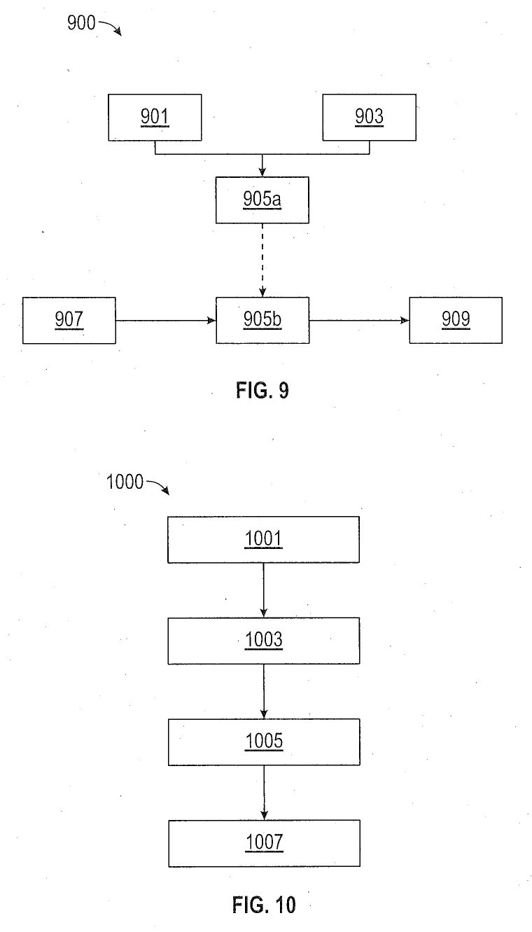

FIG. 9 shows a flowchart 900 illustrating a method in which the reflection of infrared light and the visual images can be used to train a neural network or model to recognize objects. In box 901, the processor receives the infrared image of a volume, i.e., a reflection of the structured pattern of light from an object, from the detector. In box 903, the processor receives a visual image from the detector. In box 905a, the processor determines the location of the objects from the reflection of the structured light pattern and also determines or identifies the boundary boxes that surround the object from the visual image. In doing this, the processor trains a neural network and/or a computer model to associate the boundary box of the object with a particular shape of the reflection of structured light pattern. Thereafter, in box 907, a reflection of a structured pattern of light can be received and sent to the trained network 905b. The trained network 905b identifies the object 909 using only the received light from box 907, bypassing the need to receive information from a visual image.

FIG. 10 shows a flowchart 1000 illustrating a method of navigating a vehicle using the methods disclosed herein. In box 1001, a structured pattern of light is projected from the vehicle into a surrounding volume or area. In box 1003, a reflection of the structured pattern of light is received at a detector. In various embodiments, the light is an infrared light and a filter placed in front of the detector includes a bandpass region that allows the reflected infrared light to be recorded at the detector. In box 1005, a processor detects kinks and deviations in the reflected light pattern with respect to a reflection that is expected from a pavement. An object that reflects the light causes such kinks and deviations. Therefore, the processor can determine a general shape and location of the object from the detected kinks and deviations. In box 1007, the processor provides the location and shape of the object to the vehicle so that the vehicle can be navigated with respect to the object.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof

What is claimed is:

1. A method for detecting a location of an object with respect to a vehicle, comprising:
transmitting, at the vehicle, a structured light pattern at a selected frequency into a volume that includes the object;
receiving, at a detector of the vehicle, a reflection of the light pattern from the volume;
determining, at a processor, a deviation in the reflection of the structured light pattern from the object in the volume; and
determining the location of the object in the volume from the deviation.

2. The method of claim 1, wherein the structured light pattern is a pattern of vertical stripes.

3. The method of claim 1, further comprising determining the deviation by comparing reflection intensities at a location with an expected intensity at the location from a line model indicative of reflection of the structure light pattern from a planar horizontal surface.

4. The method of claim 1, further comprising navigating the vehicle based on the location of the object.

5. The method of claim 1, further comprising capturing an image of the object and comparing the deviation in the reflection of the light pattern to the image of the object to train a neural network to associate the deviation in the reflection of the structured light pattern with the object.

6. The method of claim 5, further comprising determining a location of an object from a location of a deviation in a reflection of the light pattern and the association of the trained neural network.

7. The method of claim 1, further comprising producing the structured light pattern via at least one of: (i) a diffractive lens combined with a one-dimensional microelectromechanical system (MEMS) scanner; (ii) refractive optics with a two-dimensional MEMS scanner; (iii) an array of light sources; (iv) a polygon scanner; and (v) an optical phase array.

8. A system for detecting a location of an object with respect to a vehicle, comprising:
an illuminator configured to produce a structured light pattern at a selected frequency into a volume that includes the object;
a detector configured to detect a reflection of the light pattern from the object in the volume; and
a processor configured to:
determine a deviation in the reflection of the light pattern due to the object; and
determine the location of the object from the determined deviation.

9. The system of claim 8, wherein the illuminator produces a pattern of vertical stripes at the selected frequency.

10. The system of claim 8, wherein the processor is further configured to determine the deviation by comparing reflection intensities at a selected location with an expected intensity at the selected location from a line model indicative of reflection of the structure light pattern from a planar horizontal surface.

11. The system of claim 8, wherein the processor is further configured to navigate the vehicle based on the detected location of the object.

12. The system of claim 8, wherein the processor is further configured to illuminate the object with the pattern and compare the deviation in the reflection of the light pattern to an image of the object causing the deviation in order to train a neural network to associate the deviation of the light pattern with the selected object.

13. The system of claim 12, wherein the processor is further configured to determine a location of an object from a location of the deviation in the reflection of the light pattern and the association of the trained neural network.

14. The system of claim 8, wherein the illuminator includes at least one of: (i) a diffractive lens combined with a one-dimensional microelectromechanical system (MEMS) scanner; (ii) refractive optics with a two-dimensional MEMS scanner; (iii) an array of light sources; (iv) a polygon scanner; and (v) an optical phase array.

15. The system of claim 8, wherein the detector further comprises a filter that passes light within the visible range and with a selected range about 850 nanometers.

16. A vehicle, comprising:
an illuminator configured to produce a structured light pattern in a volume at a selected frequency;
a detector configured to detect a reflection of the light pattern from the volume; and
a processor configured to:
determine a deviation in the reflection of the light pattern due to the object; and
determine a location of the object from the determined deviation.

17. The vehicle of claim 16, wherein the illuminator produces a pattern of vertical stripes at the selected frequency.

18. The vehicle of claim 16, wherein the processor is further configured to determine the deviation by comparing reflection intensities at a selected location with an expected intensity at the selected location from a line model indicative of reflection of the structure light pattern from a planar horizontal surface.

19. The vehicle of claim 16, wherein the processor is further configured to illuminate the object with the pattern and compare the deviation in the reflection of the light pattern to an image of the object that causes the deviation in order to train a neural network to associate the deviation of the light pattern with the selected object.

20. The vehicle of claim 16, wherein the processor is further configured to determine a location of an object from a location of a deviation in a reflection of the light pattern and the association of the trained network.
